(19) United States
(12) Patent Application Publication
(10) Pub. No.: US 2002/0129240 A1
(43) Pub. Date: Sep. 12, 2002

(54) Process for transfer of data into or out of a control apparatus as memory-progrmmable control unit as well as control apparatus

(76) Inventor: Boris Sussmann, Seligenstadt (DE)

Correspondence Address: DENNISON, SCHEINER, SCHULTZ & WAKEMAN, Suite 612, 1745 Jefferson Davis Highway, Arlington, VA, 22202, US

(21) Appl. No.: 09/925,016

(22) Filed: Aug. 9, 2001

(30) Foreign Application Priority Data
Aug. 9, 2000 (DE) 100 38 779.9

(51) Int. Cl. H04L 9/00

(52) U.S. Cl. 713/155

(57) ABSTRACT

The invention relates to a process for transferring data into or out of a control apparatus (16) as a memory-programmable control unit. To increase the security of data transmission, the following operations are provided:

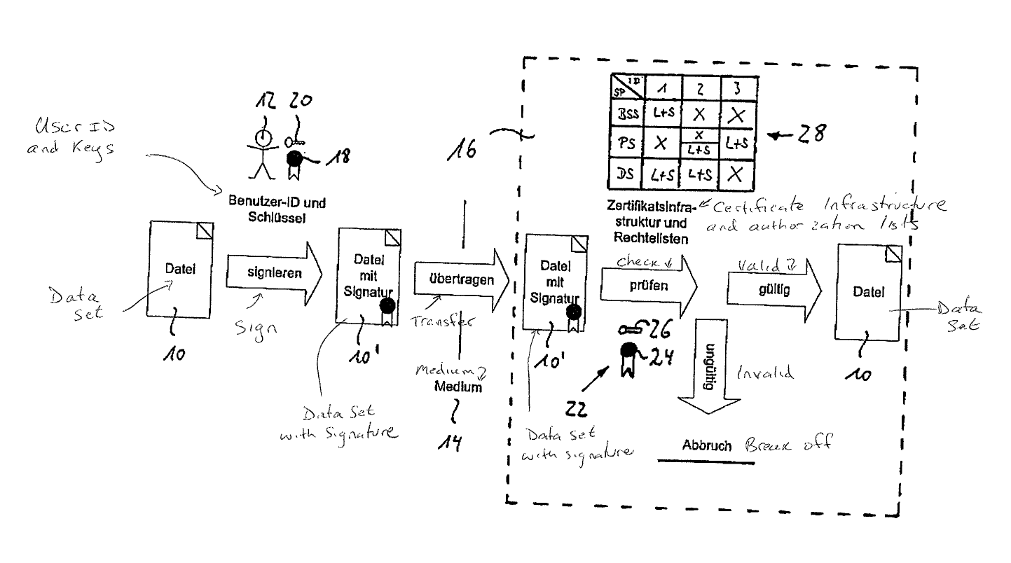

Coding data (10) on the part of the sender with at least an individual sender identification (18, 24),

Decoding data (10) on the part of the recipient and checking the individual sender identification (18, 24) and validity,

Comparison of individual sender identification (18, 24) with defined sender identifications,

Allocation of user rights for status alteration of transferred data (10) and/or of the control apparatus in accordance with an authorization list (28) filed on the part of the recipient to the extent that the individual sender identification (18, 24) is entered in the authorization list,

Rejection of data (10) to the extent that the individual sender identification is invalid or not entered into the authorization list.

A control apparatus as a memory-programmable control unit is distinguished in that a coding and decoding unit as well as authorization lists are provided in which user rights for various users are entered.

The invention relates to a process for transferring data into or out of a control apparatus as well as a control apparatus.

According to the state of the art, software updates as, for example, a firmware update, are conducted by a technician on site with a special programming apparatus in connection with a control apparatus. Here the technician has access to the entire range of memory following input of an appropriate password so that this can be manipulated. Often there exists the necessity of making available to a user of the control apparatus appropriate accesses, for example, for amending and updating processing data, whereby the disadvantage arises that important program components can be destroyed through untrained personnel.

Recently, control apparatus such as memory-programmable control units can also be manipulated or programmed through data networks, such as, for example, an Intranet or the Internet. Here, likewise, the problem arises that unauthorized persons and/or unauthorized programs/data receive access to the memory-programmable control units and consequently cause an undesired change in circumstance of the memory-programmable control units.

Proceeding from this, underlying the present invention is the problem of refining a process and a control apparatus of the type mentioned above to the effect that the security of data transfer from and to the control apparatus is improved. In particular, only authorized persons should receive access to the control apparatus.

The solution to the problem takes place through the following operations of the invention:

Coding data on the part of the sender with at least an individual sender identification,

Decoding data on the part of the recipient and checking the individual sender identification and validity,

Comparison of individual sender identification with defined sender identifications,

Allocation of user rights for status alteration of transferred data and/or of the control apparatus in accordance with an authorization list filed on the part of the recipient to the extent that the individual sender identification is entered in the authorization list,

Rejection of data to the extent that the individual sender identification is invalid or not entered into the authorization list.

The process of the invention offers the advantage that only authorized persons with a defined sender recognition and/or correspondingly coded programs are enabled access to the control apparatus. In this way, it is guaranteed that an alteration of firmware, application programs and processing data can be implemented only by the manufacturer or persons authorized for this.

A preferred embodiment provides that the data are coded on the part of the sender with a digital signature and/or a public key and that the data are decoded on the part of the recipient with an associated secret key and/or the digital signature is verified. This means that each transfer of data to or from a control apparatus as a memory-programmable control unit (SPS) is digitally signed (digital signature). Following a transfer, the signature is first checked. If this is invalid, the transferred data are rejected. Otherwise, it is verified whether the signer has the necessary rights to conduct the transfer. To the extent that the sender possesses the rights, the data are processed. Otherwise, the transferred data are rejected.

If a user digitally signs data, he adds his digital signature and if need be his certificate to the data. A certificate consists, as typical in the area of digital signatures, at least of the identification and the public key of the certificate holder and the digital signature of the certificate issuer on the holder data. The digital signature can be used in the control apparatus for verification of identity and authorization of the sender or signer and the associated public key in order to answer with coded data which only the original sender can read with his private key. There also exists the possibility of coding the data on the part of the sender with the public key of a recipient and the control apparatus.

If the control apparatus cannot directly verify the certificate, then it obtains certificates through the certificate infrastructure until a chain of certificates is built up which can be uninterruptedly verified on the basis of a verifiable certificate.

During the transfer of data from the control apparatus to a recipient, it is provided that the data in the control apparatus are coded with a digital signature so that a subsequent manipulation of the data is prevented.

In particular, transfer types and/or border areas can be defined whereby in the event of a data transfer from a control apparatus, a coding with digital signature and/or public and/or private key takes place.

Preferably the authorization list is deposited into a memory of the control apparatus on the part of the recipient. The memory range itself can be selectively actuated through the coding of the data to be transferred. The authorization list is also individually adaptable.

For further increase of security, it is provided that access rights are likewise granted for the authorization lists filed in the control apparatus. In other words, an unauthorized person cannot raid the protection by manipulation of the authorization lists.

A control apparatus as a memory-programmable control is distinguished in that this has a receiving unit with a decoding unit for decoding at least a sender identification of received data, whereby the control apparatus has an authorization list in which rights for status alteration are assigned to different sender identifications and whereby the status of the control apparatus is alterable with a valid sender identification entered on the authorization list in accordance with the rights granted in the list.

In order to guarantee that the data sent from the control apparatus as a memory-programmable control unit cannot be subsequently manipulated, it is provided that the control unit has a control unit with a coding device for coding of data to be sent, whereby a digital signature and/or public key for coding data is contained in the coding device.

The memory range of the control apparatus is subdivided into definable regions whereby for each memory range, rights are definable in an authorization list for various sender identifications. For example, the manufacturer can grant rights such that a firmware memory range can only be manipulated by a sender identification allocated to the manufacturer. In this way, there results the advantage that firmware, for example through the Intranet, can be updated or can be delivered in the form of a data set which a client of the memory-programmable control unit stores in this himself/herself. Since the signature of the data loses its validity in the event of a manipulation, only the authorized update can be imported.

The structure of the memory-programmable control unit of the invention furthermore offers the advantage that machine manufacturers (in the present case called OEM) which use the memory-programmable control unit for controlling a production device, the authorization for a program memory used by the OEM is definable such that only the OEM can describe this range and that otherwise no unauthorized entity may read this range. The authorization list can be adjusted such that a client of the OEM can store further program components in unprotected memory areas.

It is provided that a coded data transfer takes place for further securing of data transfer. In this way, for example, processing data can be transferred out to the memoryprogrammable control unit over insecure media such as, for example, the Internet. A coded data transfer can also be used by an OEM to read out an application program on the basis of the memory-programmable control unit without the application program being subject to decoding by third parties during the data transfer.

Further particularities, advantages and features of the invention emerge not [only] from the claims, the features to inferred from these (in isolation and/or in combination), but also from the description below of an embodiment to be gathered from the drawing.

The sole figure shows purely schematically a process for transferring a data set 10 through a sender such as authorized person 12 through a medium 14 which in the present example is constructed as a data network such as an Intranet or the Internet, to a recipient 16, which in the present embodiment is constructed as control apparatus 16 such as a memory-programmed control unit or a PC-based control unit.

The data set 10 to be sent is first of all coded in that a digital signature 18 of user 12 and a public key (20) are added to the data set 10. The combination on the basis of digital signature 18 and public key 20 can also be designated as a certificate which is obtainable at certification authorities (CA) such as Veri Sign, for example. The data set 10′ signed or coded in this way is transmitted coded over medium 14. In the memory-programmable control unit 16, a root certificate 22 is contained, including a digital signature 24 as well as a secret private and/or public key 20 in order to decode data set 10′. If the signature 18 is invalid, the transferred data set 10′is rejected. If the signature 18 is valid, then it is verified whether the user 12 has the necessary rights to conduct the transfer. For this, an authorization list 28 is filed in the control apparatus 16 in the form of a table. If these rights exist, the data set 10 can be processed. A memory range of the memory-programmable control unit 16 is subdivided into definable areas (BSS, PS, DS) in accordance with the embodiment. For each memory area, as for example, operating system memory (BSS), program memory (PS) as well as data memory (DS), rights such as, for example, read (L) and/or write (S) are defined in table 28 for each sender identification ID1 . . . IDn, that is, for each sender-side digital signature ID 1, ID 2 . . . IDn.

In the embodiment represented here, a total of three users ID 1 . . . ID 3 as well as three memory ranges BSS, PS and DS are defined. Sender identification ID 1, for example, is assigned to the manufacturer of the memory-programmable control unit 16. As soon as a data set 10′ with the signature ID 1 is recognized, the rights read and write are granted for all memory regions. Through the represented authorization table, for example, only the manufacturer is allowed to address the firmware memory range BSS. By way of example, a signed data set 10′ can also be delivered to a client with the possibility that the client imports the data set into the memory-programmable control unit 16 without having access to the memory itself.

There also exists the possibility that a machine manufacturer (OEM) programs the authorization for the program memory used by him/her, that only the OEM can describe the region and no unauthorized entity can read out of it, whereby nevertheless the client can accommodate further program components in unprotected program memory areas.

Of course, there exists the possibility that a certificate infrastructure consisting of the public key (26), a private key and a digital signature 24 are contained in the memory-programmable control unit 16 itself. In this way, transfer types or memory ranges can be defined where the memory-programmable control unit digitally signs data owing to which a subsequent manipulation of the data is prevented. Obviously, access rights are also used for the authorization lists/tables 28, so that none unauthorized can raid the protection through manipulation of the lists.

Furthermore, with the certificate infrastructure 18, 20, 22, 24, 26, a coded data transfer can be implemented so that processing data from the memory-programmable control unit can also be transferred over media, for example the Internet. The coded data transfer can also be used by a machine manufacturer to read application programs out of the machine which may not be accessible to third parties.

1. Process for transferring data into or out of a control apparatus (16) as a memory-programmable control unit, characterized by the following operations:
Coding data (10) on the part of the sender with at least an individual sender identification (18, 24),
Decoding data (10) on the part of the recipient and checking the individual sender identification (18, 24) and validity,
Comparison of individual sender identification (18, 24) with defined sender identifications (ID 1, ID 2 . . . IDn),
Allocation of user rights for status alteration of transferred data (10) and/or of the control apparatus in accordance with an authorization list (28) filed on the part of the recipient to the extent that the individual sender identification (18, 24) is entered in the authorization list,
Rejection of data (10) to the extent that the individual sender identification (18) is invalid or not entered into the authorization list (28).

2. Process according to claim 1, characterized in that the authorization list (28) is deposited in a memory of the control apparatus (16) on the part of the recipient.

3. Process according to claim 1 or 2, characterized in that a memory range (BSS, PS, DS) of the control apparatus (16) constructed as a memory-programmable control unit is selectively actuatable through coding of the data set to be transferred.

4. Process according to at least one of the preceding claims, characterized in that the authorization list (28) is individually adaptable, whereby a manipulation of the authorization list (28) is possible only with the corresponding rights.

5. Process according to at least one of the preceding claims, characterized in that transfer types and/or memory ranges (BSS, PS, DS) are defined, whereby a coding with digital signature (24) and/or public and/or private key (26) takes place in the event of a data transfer out of the data processing apparatus.

6. Process according to at least one of the preceding claims, characterized in that the data (10) are coded on the part of the sender with a digital signature (18) and a public key (20), and in that the data (10) are decoded on the part of the recipient with an associated secret key (22).

7. Process according to at least one of the preceding claims, characterized in that the data (10) are transmitted coded.

8. Process according to at least one of the preceding claims, characterized in that the data (10) are transferred over a data network (14) such as an Intranet or the Internet.

9. Control apparatus as memory-programmable control unit, characterized in that the control apparatus (16) has a receiver unit with a decoding unit for decoding at least a sender identification (18) of received data (10′), in that the control apparatus (16) has an authorization list (28) in which rights for altering the status of the control apparatus (16) are assigned to various sender identifications (ID 1 . . . IDn), and in that the status of the control apparatus is alterable with a valid sender identification (ID 1 . . . IDn) contained in the authorization list) in according with the rights granted in the authorization list.

10. Control apparatus according to claim 9, characterized in that the control apparatus (16) has a sending unit for coding data (10) to be sent, in that in the coding device a digital signature and/or a public key is contained for coding data.

11. Control apparatus according to claim 9 or 10, characterized in that the memory range of the memoryprogrammable control unit is subdivided into definable regions (BSS, PS, DS), whereby for each memory range (BSS, PS, DS) in the authorization list (28), rights for different sender identifications (ID 1, ID 2, IDn) are definable.

12. Control apparatus according to claim 11, characterized in that the control apparatus is a memory-programmable control unit.
